(19) United States
(12) Patent Application Publication
(10) Pub. No.: US 2013/0201959 A1
(43) Pub. Date: Aug. 8, 2013

(54) METHOD AND APPARATUS FOR MAKE-BEFORE-BREAK HANDOVER IN A TD-SCDMA SYSTEM

(71) Applicants: Jiming Guo, Beijing (CN); Mingxi Fan, San Diego, CA (US)

(72) Inventors: Jiming Guo, Beijing (CN); Mingxi Fan, San Diego, CA (US)

(73) Assignee: QUALCOMM Incorporated, San Diego, CA (US)

(21) Appl. No.: 13/575,288

(22) PCT Filed: Aug. 26, 2010
(86) PCT No.: PCT/CN10/76376

§ 371 Date: Feb. 27, 2013

(30) Foreign Application Priority Data
Feb. 26, 2010 (CN) 2010/070779

(51) Int. Cl. H04W 36/18

(52) U.S. Cl. CPC H04W 36/18
USPC 370/331

(57) ABSTRACT

A system and method enable make-before-break handover from a source cell to a target cell in a TD-SCDMA system. According to various aspects of the present disclosure, a wireless link is established with the target cell while maintaining the call with the source cell. The communication between the mobile station and the respective source and target cells may be multiplexed utilizing time division multiplexing or frequency division multiplexing. When utilizing time division multiplexing, the allocation between the respective source and target cells may be made slot-by-slot in a subframe, or subframe-by-subframe in a radio frame.

### BACKGROUND

1. Field

Aspects of the present disclosure relate generally to wireless communication systems, and more particularly, to handovers in cellular wireless communication systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

A system and method enable make-before-break handover from a source cell to a target cell in a TD-SCDMA system. According to various aspects of the present disclosure, a wireless link is established with the target cell while maintaining the call with the source cell. The communication between the mobile station and the respective source and target cells may be multiplexed utilizing time division multiplexing or frequency division multiplexing. When utilizing time division multiplexing, the allocation between the respective source and target cells may be made slot-by-slot in a subframe, or subframe-by-subframe in a radio frame.

In an aspect of the disclosure, a method of wireless communication in a TD-SCDMA system includes determining to perform a handover from a source cell to a target cell, establishing a link with the target cell while maintaining a call with the source cell, terminating a link corresponding to the call with the source cell after the link with the target cell is established, and continuing the call utilizing the established link with the target cell.

In another aspect of the disclosure, a method of wireless communication in a TD-SCDMA network includes determining to perform a handover from a source cell to a target cell, providing a target cell handover configuration message to the target cell, providing a source cell handover configuration message to the source cell, providing a handover command to a mobile user equipment, and receiving a handover complete message from the mobile user equipment when the handover is complete.

In yet another aspect of the disclosure, an apparatus for wireless communication in a TD-SCDMA system includes means for determining to perform a handover from a source cell to a target cell, means for establishing a link with the target cell while maintaining a call with the source cell, means for terminating a link corresponding to the call with the source cell after the link with the target cell is established, and means for continuing the call utilizing the established link with the target cell.

In yet another aspect of the disclosure, a computer program product for use in a TD-SCDMA system includes a computer-readable medium having code for determining to perform a handover from a source cell to a target cell, establishing a link with the target cell while maintaining a call with the source cell, terminating a link corresponding to the call with the source cell after the link with the target cell is established, and continuing the call utilizing the established link with the target cell.

In yet another aspect of the disclosure, an apparatus for wireless communication includes at least one processor and a memory coupled to the at least one processor. Here, the at least one processor is configured to determine to perform a handover from a source cell to a target cell. establish a link with the target cell while maintaining a call with the source cell, terminate a link corresponding to the call with the source cell after the link with the target cell is established, and continue the call utilizing the established link with the target cell.

These and other aspects are more fully comprehended upon review of this disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 conceptually illustrates a baton handover in accordance with the prior art.

FIG. 5 is a call flow diagram conceptually illustrating a baton handover in accordance with the prior art.

FIG. 6 is a call flow diagram conceptually illustrating a make-before-break handover in accordance with an aspect of the present disclosure.

FIG. 7 is a flow chart conceptually illustrating the make-before-break handover in accordance with the procedure illustrated in FIG. 6.

FIG. 8 conceptually illustrates an aspect of a make-before-break handover utilizing slot-level time division multiplexing in accordance with an aspect of the present disclosure.

FIG. 9 is a flow chart conceptually illustrating a process of changing a carrier frequency following a make-before-break handover in accordance with an aspect of the present disclosure.

FIG. 10 conceptually illustrates an aspect of a make-before-break handover utilizing subframe-level time division multiplexing in accordance with an aspect of the present disclosure.

FIG. 11 conceptually illustrates an aspect of a make-before-break handover utilizing frequency division multiplexing in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

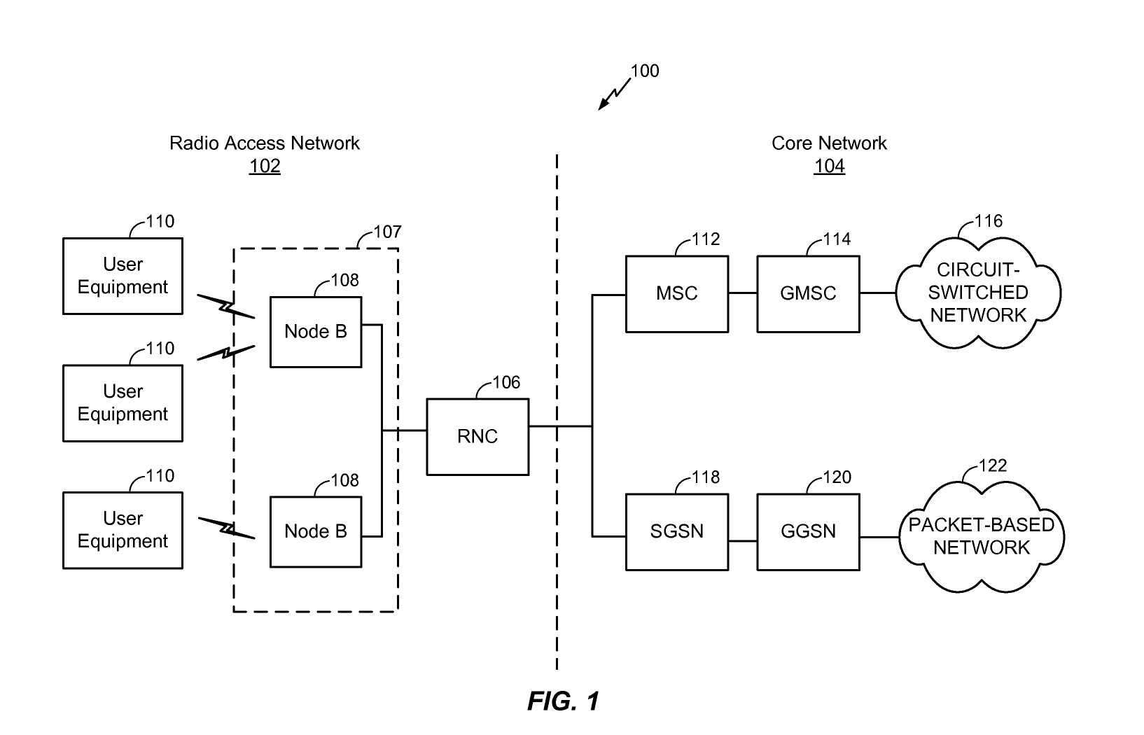

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

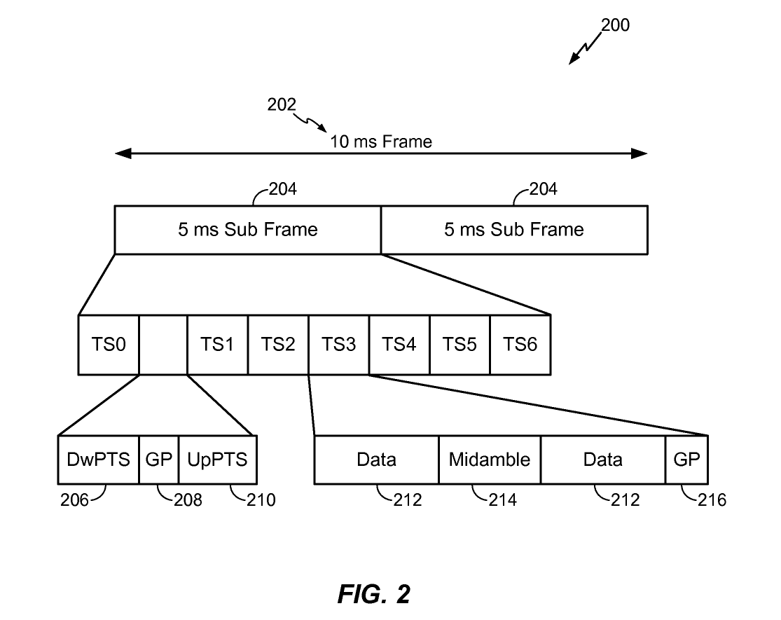

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

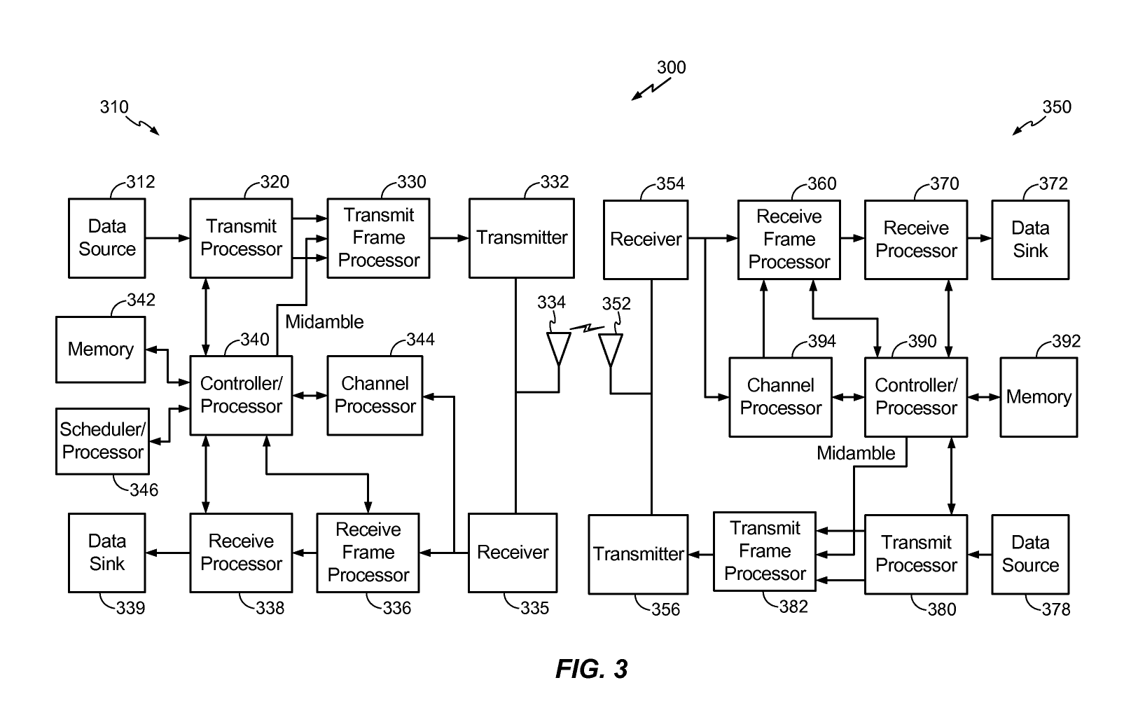

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one configuration, an apparatus 350 for wireless communication in a TD-SCDMA system includes means for determining to perform a handover from a source cell to a target cell; means for establishing a link with the target cell while maintaining a call with the source cell means for terminating a link corresponding to the call with the source cell after the link with the target cell is established; and means for continuing the call utilizing the established link with the target cell. In one aspect, the aforementioned means may be the processor(s) 370, 380, and/or 390, configured to perform the functions recited by the aforementioned means. In another aspect, the aforementioned means may be a module or any apparatus configured to perform the functions recited by the aforementioned means.

In a further configuration, the apparatus 350 further includes means for redirecting an uplink with the target cell to a third carrier different from the first carrier after the handover is complete; and means for redirecting a downlink with the target cell to a fourth carrier different from the second carrier after the handover is complete. In one aspect, the aforementioned means may be the processor(s) 370, 380, and/or 390, configured to perform the functions recited by the aforementioned means. In another aspect, the aforementioned means may be a module or any apparatus configured to perform the functions recited by the aforementioned means.

In contrast to other commercial CDMA systems such as cdma2000 and W-CDMA, which support a soft handover, current TD-SCDMA systems may only utilize a hard handover and a baton handover, both of which are break-before-make handovers. That is, a connection with a first Node B (i.e., a source Node B) is broken before a connection with a second Node B (i.e., a target Node B) is made.

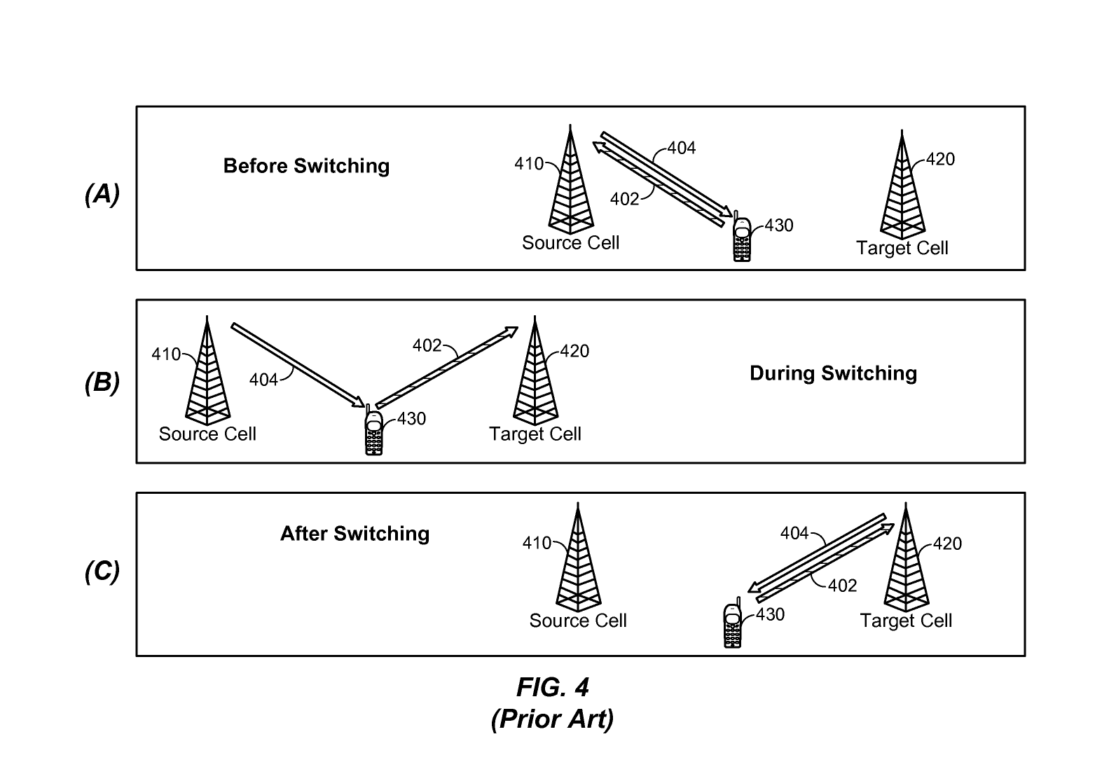

When utilizing the hard handover, the UE first breaks the radio links corresponding to both the uplink and the downlink with the original source Node B, and then establishes a reliable radio link on both the uplink and downlink with the target Node B before being served with voice and data traffic. When utilizing the baton handover, as illustrated in FIG. 4, the uplink 402 is first switched from the source Node B 410 to the target Node B 420. Here, the uplink 402 may utilized to transmit a special burst (SB) to the target Node B 420, which may be considered a kind of training sequence for the target Node B 420 to detect the uplink 402 from the UE 430. Following a suitable downlink/uplink switching delay period, the downlink 404 is then switched from the source Node B 410 to the target Node B 420.

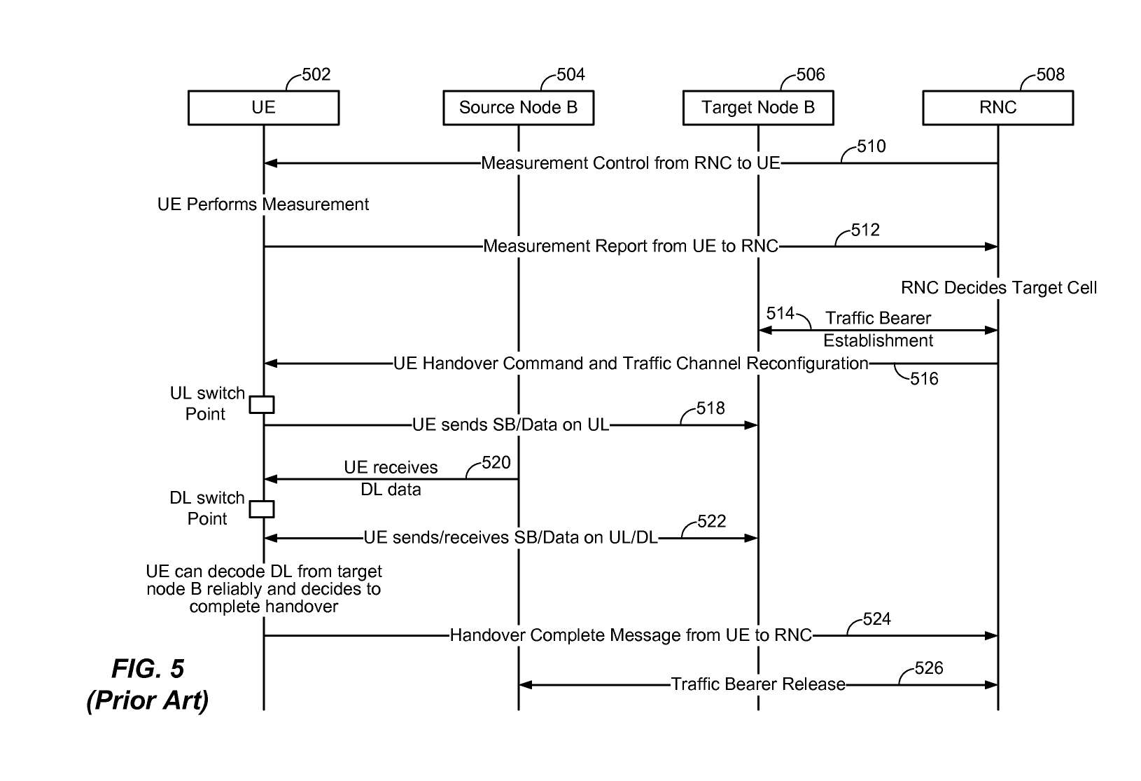

FIG. 5 is a call flow diagram illustrating further details related to a break-before-make baton handover as implemented in the prior art. In the illustration, the process begins when an RNC 508 provides a MEASUREMENT CONTROL message 510 to the UE 502. Here, the MEASUREMENT CONTROL message 510 may include certain information regarding measurements that the RNC 508 is requesting for the UE 502 to perform, such as inter- or intra-frequency measurements, inter-RAT measurements, quality measurements such as error rates, UE internal measurements, etc. After performing the requested measurement(s), the UE 502 responds to the RNC 508 with a MEASUREMENT REPORT message 512, which generally includes information about the measurement(s) performed by the UE 502 in response to the MEASUREMENT CONTROL message 510. This MEASUREMENT CONTROL-measurement-MEASUREMENT REPORT sequence may repeat periodically or when a requested measurement event is triggered.

Here, after receiving the MEASUREMENT REPORT message 512, the RNC 508 decides on a target Node B 506 for a handover to occur, and executes Traffic Bearer Establishment signaling 514 with the chosen target Node B 506. Next, the RNC 508 provides a handover command including traffic channel configuration information 516 to the UE 502. Here, because a baton handover is being utilized, the handover from the source Node B 504 to the target Node B 506 begins with the UE 502 switching the uplink before switching the downlink. That is, after the uplink switch point, the UE 502 transmits a special burst (SB) 518 and/or data on the uplink to the chosen target Node B 506. Here, the SB 518 is a training sequence for traffic channel establishment at the target Node B 506.

Prior to a downlink switch point, the UE 502 maintains the downlink from the source Node B 504, that is, it continues to receive downlink data 520 from the source Node B 504. However, after the downlink switch point, which is generally about 80 ms after the uplink switch point, the downlink is switched to the target Node B 506. The handover is completed after detection of the establishment of the downlink, and the transmission of a handover complete message 524 to the RNC 508. Thus, the RNC 508 sends a traffic bearer release message 526 to the source Node B 504.

A known issue with the baton handover as described above is that during switching, that is, when the uplink and the downlink are at different base stations (see FIG. 4 (row B), both the uplink 402 and downlink 404 are in open loop transmission mode. That is, feedback information such as a TPC and SS command are generally not provided in the uplink/downlink transmission 402, and therefore, power and synchronization control may be compromised. Open loop transmission may lead to power inefficiency, e.g., interference in the uplink, and packet loss due to a lack of adaptation to fluctuations or changes in the channel conditions.

Further, baton handovers as described above are generally not applicable to HSPA traffic due to the requirements in existing standards for the associated uplink signaling channel.

Thus, in an aspect of the present disclosure, the handover procedure is modified to achieve a make-before-break handover user experience in a TD-SCDMA system. Here, a reliable radio link may be established with the target Node B while maintaining voice/data communication with the source Node B. Once the reliable radio link is confirmed, the voice/data communication may then be switched to the target Node B.

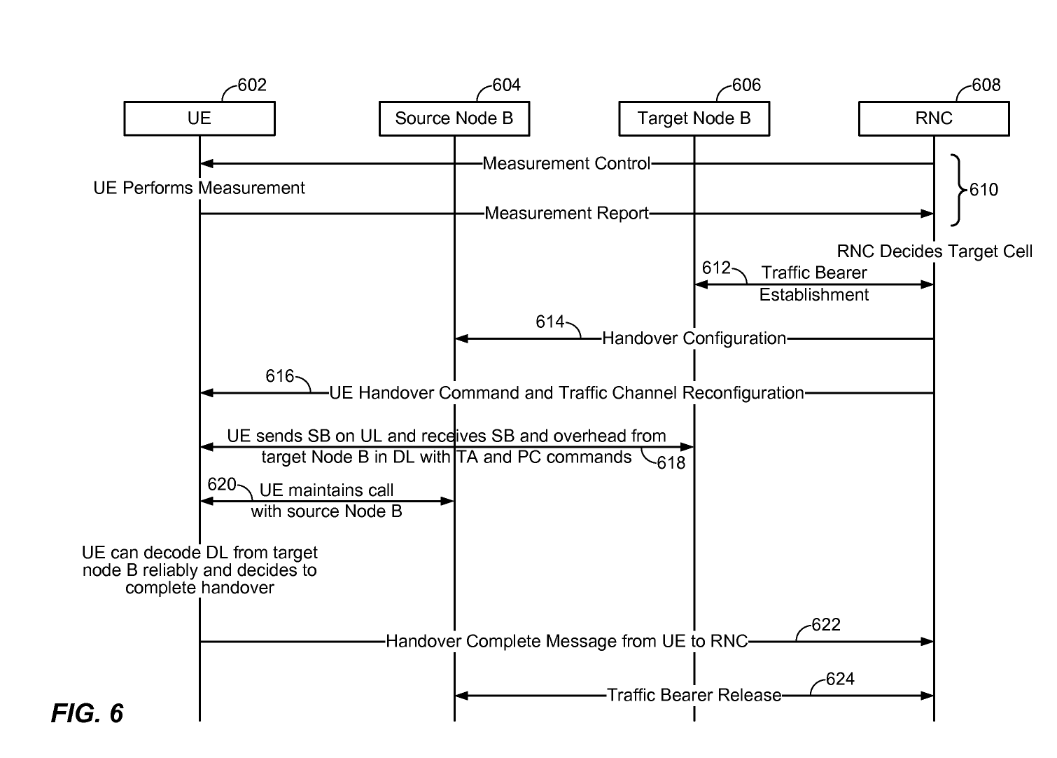

FIG. 6 is a call flow diagram illustrating a make-before-break handover procedure in a TD-SCDMA system according to an aspect of the instant disclosure. In substantially the same way as the process described with reference to FIG. 5, the UE and the RNC execute a MEASUREMENT CONTROL-measurement-MEASUREMENT REPORT sequence, resulting in a determination that a handover should take place. After the RNC 608 decides on a target Node B 606 for a handover to occur, the RNC 608 may execute Traffic Bearer Establishment signaling 612 with the chosen target Node B 606. However, as discussed in further detail below, unlike the Traffic Bearer Establishment signaling 514 illustrated in FIG. 5, the Traffic Bearer Establishment signaling 612 may include a Handover Configuration message for informing the target Node B 606 of certain configuration parameters to be utilized during the make-before-break handover. The RNC 608 may further provide a Handover Configuration message 614 to the source Node B 604, informing the source Node B 604 of certain configuration parameters to be utilized during the handover, as described in further detail below.

Next, the RNC 608 may provide a handover command 616 including traffic channel reconfiguration information to the UE 602, and in response the UE 602 may determine to perform the handover, and thereby may begin the handover from the source Node B 604 to the target Node B 606. Here, as the process may be characterized as a make-before-break handover procedure, the UE 602 maintains a traffic connection with the source Node B 604 on both the uplink and the downlink. For example, the UE 602 may maintain a call 620 with the source Node B 604, where herein a call refers to any traffic connection, e.g., an ongoing voice and/or data transmission/reception with a network by utilizing an air interface with the source Node B 604. At the same time, the UE 602 may establish a link 618 with the target Node B 606, for example, by sending a special burst (SB) on the uplink and receiving a SB and overhead on a downlink from the target Node B 606. Further, the downlink signaling from the target Node B 606 to the UE 602 may include timing advance (TA) and power control (PC) messages. In this way, the UE 602 is able to actively configure characteristics of the uplink transmissions to the target Node B 606 in response to the feedback provided on the downlink from the target Node B 606, to suitably establish the radio link 618 with the target Node B 606.

As the UE 602 becomes satisfied that it is capable of reliably decoding the downlink messages from the target Node B 606, it may be determined to complete the handover to the target Node B 606, in which case the UE 602 may notify the RNC 608 by utilizing a Handover Complete message 622. Thereafter, the RNC 608 may provide a Traffic Bearer Release message 624 to the source Node B 604, and the UE 602 may terminate its communication links with the source Node B 604. Thus, the UE 602 may continue its call over the respective uplink and downlink with the target Node B 606.

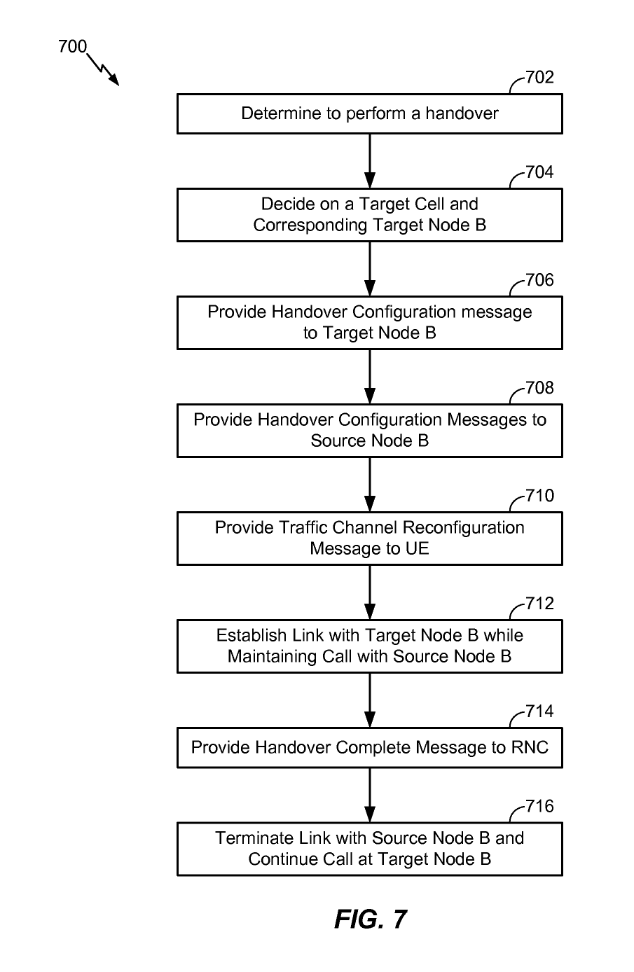

FIG. 7 is a flow chart illustrating some of the aspects of the process illustrated in the call flow diagram of FIG. 6. In some embodiments the process is performed by circuitry or a network processor. In some embodiments the process is performed by various components of the telecommunications system 100 illustrated in FIG. 1. In some embodiments portions of the process are performed by the UE 350 of FIG. 3.

In block 702 the process determines to perform a handover of a UE from a source cell and its corresponding Node B to a target cell and its corresponding Node B. In some aspects of the disclosure the determining to perform the handover may be implemented by a radio network controller (RNC) in response to a MEASUREMENT CONTROL-measurement-MEASUREMENT REPORT sequence as described above. The process thereafter in block 704 decides on a target cell and its corresponding target Node B in accordance with the measurements performed by the UE.

In block 706, the process provides a Handover Configuration message to the target Node B. In some aspects of the disclosure, the Handover Configuration message may be provided by the RNC as a part of Traffic Bearer Establishment signaling with the target Node B sent over a backhaul connection. In some aspects of the disclosure, the Handover Configuration message provided to the target Node B may include resource allocation information for enabling a make-before-break handover to the target Node B, such as slot assignments for slot-level TDM, subframe assignments for subframe-level TDM, channel assignments for FDM, and any further restrictions or rules that may be suitable for the particular call to be handed over from the source Node B to the target Node B.

In block 708, the process provides a Handover Configuration message to the source Node B. In some aspects of the disclosure, the Handover Configuration message provided to the source Node B may be provided by the RNC sent over a backhaul connection. In some aspects of the disclosure, the Handover Configuration message provided to the source Node B may include resource allocation information for enabling a make-before-break handover from the source Node B, such as slot assignments for slot-level TDM, subframe assignments for subframe-level TDM, channel assignments for FDM, and any further restrictions or rules that may be suitable for the particular call to be handed over from the source Node B to the target Node B.

In block 710, the process provides a Traffic Channel Reconfiguration message to the UE. In some aspects of the disclosure, the Traffic Channel Reconfiguration message may be provided by the RNC to the UE by utilizing a higher-layer connection. In some aspects of the disclosure, the Traffic Channel Reconfiguration message may be provided alongside a UE Handover Command instructing the UE to execute a handover from the source Node B to the target Node B. In some aspects of the disclosure, the Traffic Channel Reconfiguration message may provide the UE with an allocation of resources between the source Node B and the target Node B for enabling a make-before-break handover, such as slot assignments for slot-level TDM, subframe assignments for subframe-level TDM, channel assignments for FDM, and any further restrictions or rules that may be suitable for the particular call to be handed over from the source Node B to the target Node B.

In block 712, the process establishes a link with the target Node B while maintaining a call with the source Node B. In some aspects of the disclosure, establishing the link includes closed-loop communication between the UE and the target Node B including feedback to enable the uplink and downlink to be dynamically adjusted. For example, the UE may provide a special burst (SB) on the uplink and may receive a SB and overhead on a downlink from the target Node B. Further, the downlink signaling from the target Node B to the UE may include timing advance (TA) and power control (PC) messages to enable the UE to adapt the timing and power of the uplink transmissions. Those skilled in the art will comprehend that other signaling may be utilized between the UE and the Node B to establish the link. In some aspects of the disclosure, the establishing of the link with the target Node B may be multiplexed with the call being maintained with the source Node B, utilizing slot-level time division multiplexing, subframe-level time division multiplexing, or frequency division multiplexing, as described in further detail below.

In block 714, the process provides a Handover Complete message from the UE to the RNC. In some aspects of the disclosure, the Handover Complete message may notify the network that the link with the target Node B is suitable for the call to be maintained after being switched from the source Node B to the target Node B. Thereafter, in block 716 the process switches the call from the source Node B to the target Node B and terminates the link with the source Node B.

According to various aspects of the disclosure, the maintaining of the call with the source Node B while establishing the link with the target Node B may be achieved utilizing any of several different strategies, described below. In each of the below-described strategies, the uplink transmissions from the UE are provided to the source Node B and the target Node B utilizing various multiplexing schemes, and the respective downlink transmissions from the source and target Node Bs are provided to the UE utilizing various multiple access schemes. For ease of description, the multiplexing and multiple access strategies are together referred to as multiplexing.

Slot-Level TDM

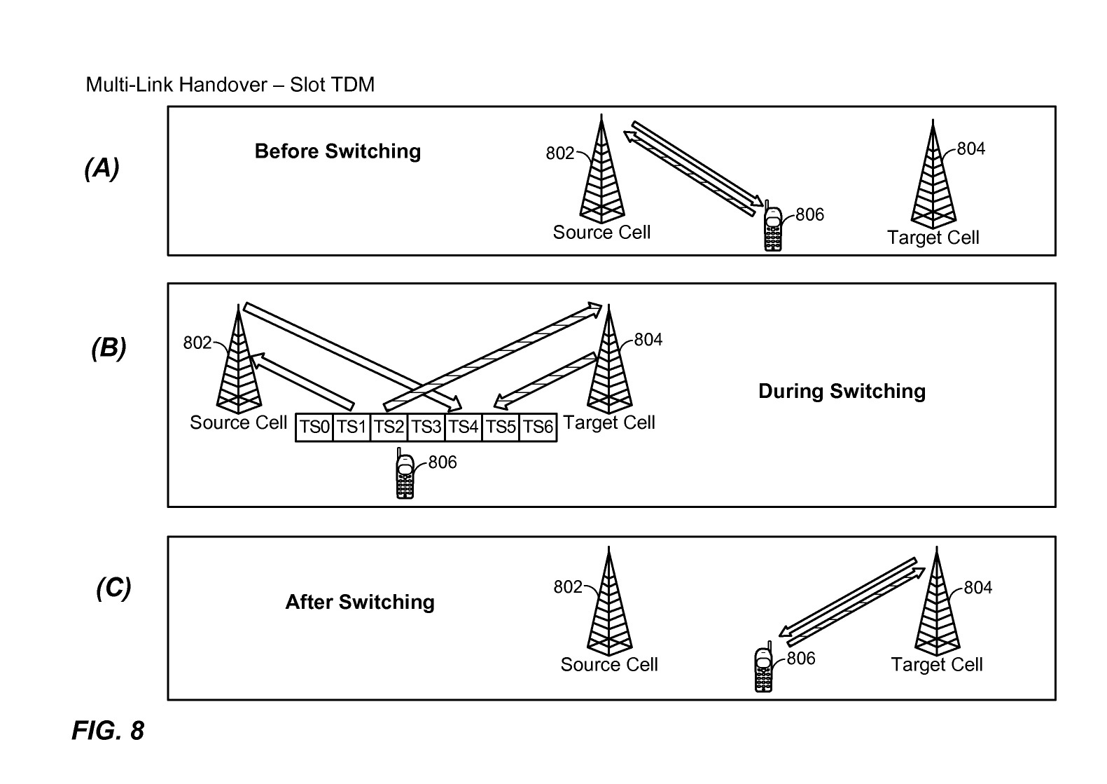

According to an aspect of the present disclosure, signaling to/from a source and target Node B during a make-before-break handover in a TD-SCDMA system may be distributed utilizing time division multiplexing at a slot level. That is, different time slots (TS) in the same subframe 204 of a radio frame 202 (see FIG. 2) may be allocated to the source Node B or the target Node B, respectively. For example, as illustrated in FIG. 8 (row B), time slot TS 1 may be allocated to uplink transmissions to the source Node B 802; time slot TS2 may be allocated to uplink transmissions to the target Node B 804; time slot TS4 may be allocated to downlink transmissions from the source Node B 802; and time slot TS5 may be allocated to downlink transmissions from the target Node B 804. Of course, those skilled in the art will comprehend that any suitable allocation of time slots to the respective source and target Node B may be utilized without departing from the scope of the present disclosure, including multiple time slots for uplink and/or downlink to any respective Node B, and/or omission of one or more of the uplink/downlink transmissions.

Referring back to FIG. 6, the RNC 608 may negotiate with the target Node B 606 to set up the channel resources to be utilized by the UE 602 and the target Node B 606 during the handover procedure. In one example, this negotiation with the target Node B 606 may be accomplished during the Traffic Bearer Establishment signaling 612. Similarly, allocation of channel resources may be communicated to the source Node B 604 in the Handover Configuration message 614. Moreover, the allocation of channel resources between the source Node B 604 and the target Node B 606 may be communicated to the UE 602 as the Traffic Channel Reconfiguration message 616. For example, if the UE 602 is handing over one or more dedicated channels (DCH), the DCH channel slot assignment at the target Node B 606 should be different from the DCH channel slot assignment at the source Node B 604. Further, if the UE 602 is handing over one or more HS channels, the RNC 608 may restrict the time slots on which the HS service is provided to the UE 602 from each Node B for coordination purposes. Further resource assignment rules may apply when a handover utilizes slot-level TDM according to this aspect of the disclosure, with specifics accounted for during the Traffic Bearer Establishment signaling 612 with the target Node B 606 and the Handover Reconfiguration message 614 to the source Node B 604. For example, if data is being transmitted utilizing HSPA, the data generally is disallowed from spanning multiple time slots within a subframe, because other slots should be allocated for transmission to the other Node B.

Further, it may be observed that, as illustrated in FIG. 8, the uplink transmission may switch from the source Node B to the target Node B in adjacent time slots (e.g., as illustrated, switching from an uplink transmission to the source Node B 802 in TS1 to an uplink transmission to the target Node B 804 in TS2, which is adjacent to TS1). In at least this case, according to a further aspect of the present disclosure, the uplink transmissions to the source and target Node Bs may utilize the same carrier frequency during the handover procedure. That is, switching the RF frequency between different carriers takes time, for example, at least 300 μs. Here, when utilizing slot-level TDM, the time slots each have a time span that is generally on the same order as the RF frequency switching time, making it difficult to switch between carrier frequencies while maintaining useful time for transmissions in the time slots. Similarly, the downlink transmissions may come from the respective source and target Node B in adjacent time slots. Here, to receive downlink transmissions at different carrier frequencies, the UE 806 may be required to change its receiver to tune into the different carrier, which similarly takes time away from the limited amount of time available in each time slot. Thus, according to a further aspect of the present disclosure, the downlink transmissions from the source and target Node Bs should utilize the same carrier frequency during the handover procedure.

In a situation in which it is desired to execute a make-before-break handoff procedure utilizing slot-level TDM from a source Node B 802, which utilizes a first carrier frequency, to a target Node B 804, which utilizes a second carrier frequency different from the first frequency, the following procedure may be implemented according to an aspect of the present disclosure. That is, during the handover phase while utilizing slot-level TDM, the UE 806 may establish the closed-loop communication (i.e., the uplink transmission and downlink reception) with the target Node B 804 utilizing the same carrier that is utilized by the source Node B 802. That is, the target Node B 804 may utilize a different carrier than the carrier frequency to which the handover is intended to take place. After the handoff to the target Node B 804 is complete, the target Node B 804 may redirect the UE 806 to utilize the second carrier, while utilizing the same TA as was being used at the first carrier frequency after establishing the link with the target Node B 804. Here, because the same configuration of the system frame number (SFN) and default DPCH offset (DOFF) on the different carriers at the target Node B 804, voice frame erasure is not expected during a channel reconfiguration.

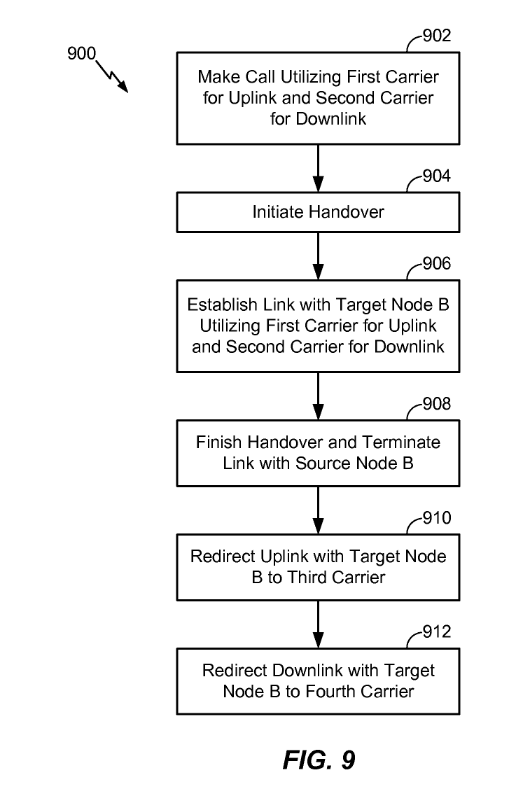

FIG. 9 is a flow chart illustrating a process for inter-frequency handover while utilizing slot-level TDM according to an aspect of the present disclosure. In some embodiments the process is performed by circuitry or a network processor. In some embodiments the process is performed by various components of the telecommunications system 100 illustrated in FIG. 1. In some embodiments portions of the process are performed by the UE 350 of FIG. 3.

In block 902, the process makes a call to a first Node B (herein, the source Node B) utilizing a first carrier for an uplink and a second carrier for a downlink. Here, a carrier may refer to a specific frequency, or to a suitable range of frequencies for a broadband or narrowband wireless communications link. Here, the first carrier may be the same frequency as, or a different frequency than the second carrier. In a case where the first and second carrier use the same frequency or range of frequencies, time division duplexing may be utilized. In some aspects of the disclosure, a UE may make the call with the source Node B.

In block 904, the process initiates a handover. In some aspects of the disclosure, a radio network controller (RNC) may provide an instruction to the UE to initiate the handover from the source Node B to a target Node B. In block 906, the process establishes a link between the UE and the target Node B. Here, the link with the target Node B may utilize a first carrier for the uplink to the target Node B, and a second carrier for the downlink from the target Node B. In some aspects of the disclosure, the first carrier may be the same frequency or range of frequencies as that of the second carrier; in other aspects of the disclosure the first carrier may be a different frequency or range of frequencies than that of the second carrier.

In block 908, the process finishes the handover procedure from the source Node B to the target Node B, and terminates the link with the source Node B. In block 910, the process redirects the uplink between the UE and the target Node B from the first carrier to a third carrier different from the first carrier; and in block 912 the process redirects the downlink between the UE and the target Node B from the second carrier to a fourth carrier different from the second carrier. In some aspects of the disclosure, the third carrier may be the same frequency or range of frequencies as that of the fourth carrier; in other aspects of the disclosure the third carrier may be a different frequency or range of frequencies than that of the fourth carrier. In a case where the third and fourth carrier use the same frequency or range of frequencies, time division duplexing may be utilized.

Subframe-Level TDM

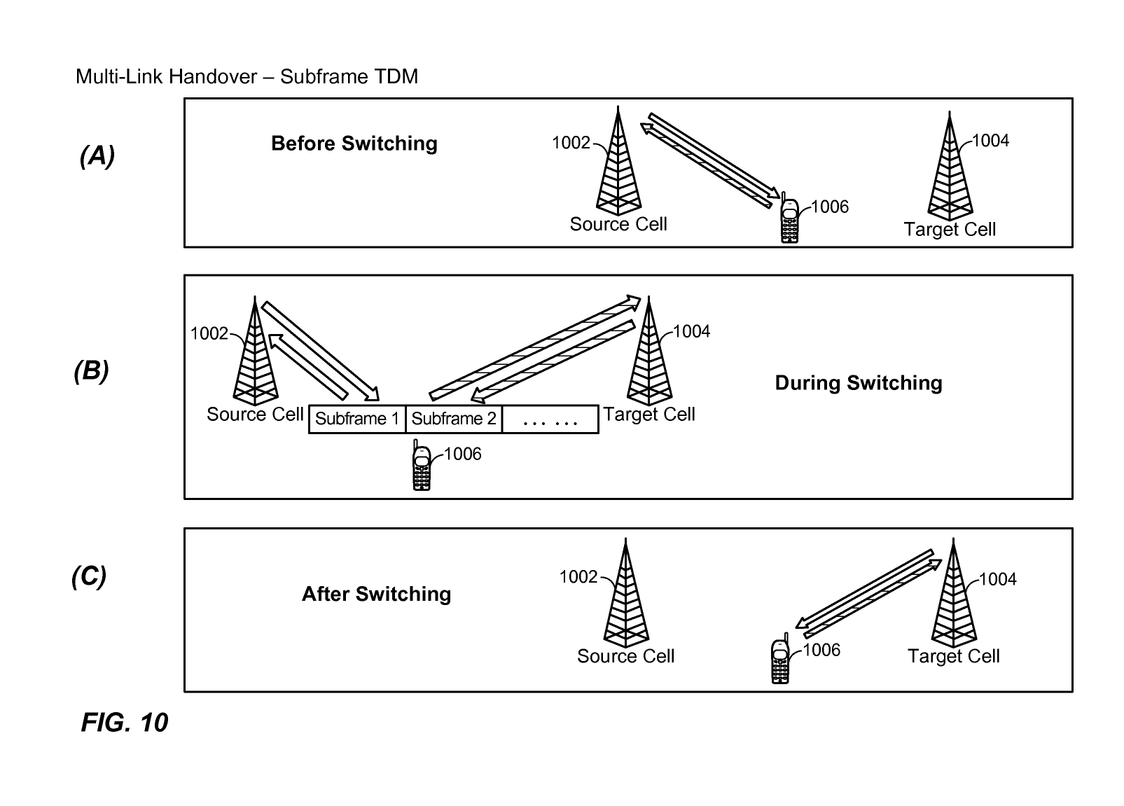

According to an aspect of the present disclosure, as illustrated in FIG. 10 (row B), signaling to/from the source and target Node B during a make-before-break handover in a TD-SCDMA system may be distributed utilizing time division multiplexing at a subframe level. That is, different subframes 204 in the same radio frame 202 (see FIG. 2) may be allocated to the source Node B or the target Node B, respectively. For example, as illustrated in FIG. 10 (row B), subframe 1 is allocated for both uplink and downlink transmissions to/from the source Node B 1002, while subframe 2 is allocated for both uplink and downlink transmissions to/from the target Node B 1004. Of course, those skilled in the art will comprehend that the subframes of a radio frame may take the reverse configuration, namely, subframe 1 being assigned to the target Node B 1004 and subframe 2 being assigned to the source Node B 1002. Furthermore, those skilled in the art will comprehend that subframe-level TDM may be implemented with alternate subframe assignments within the scope of this disclosure, for example, every third subframe, every fourth subframe, or any suitable allocation of subframes between the respective source and target Node Bs.

According to this aspect of the disclosure, the allocation of different subframes to the source and target Node Bs, respectively, may utilize the same carrier for the respective source and target Node Bs. Alternately, in distinction some examples of slot-level TDM as described above, subframe timing is generally long enough to accommodate a change in carrier frequencies from one subframe to the next. Thus, the allocation of different subframes to the source and target Node Bs, respectively, may utilize different carriers for the respective source and target Node Bs.

Returning to FIG. 6, when utilizing subframe-level TDM, the RNC 608 may inform the target Node B 606 of subframes assigned to it by utilizing a Handover Configuration message included with the Traffic Bearer Establishment message 612; and the RNC 608 may similarly inform the source Node B 604 of subframes assigned to it in a Handover Configuration message 614. Further, the allocation of subframes between the respective source and target Node Bs may be communicated to the UE 602 as a part of a Traffic Channel Reconfiguration message 616.

During a circuit-switched voice call, one voice frame generally spans four consecutive subframes. Thus, because it may result in an unsatisfactory degradation of voice call quality, allocation of subframes within the same radio frame to different Node Bs may not be an optimal solution for make-before-break handoff of voice calls. That is, for a voice call handoff, subframe-level TDM may be provided on a four-subframe allocation basis rather than the one-subframe allocation basis illustrated in FIG. 10. Those skilled in the art will recognize that a four-subframe allocation basis may come at the expense of nulling every other voice frame for the voice call connection at the source Node B. During a packet-switched HSPA call, the introduction of subframe-level TDM may lead to data throughput loss on the UE side.

FDM

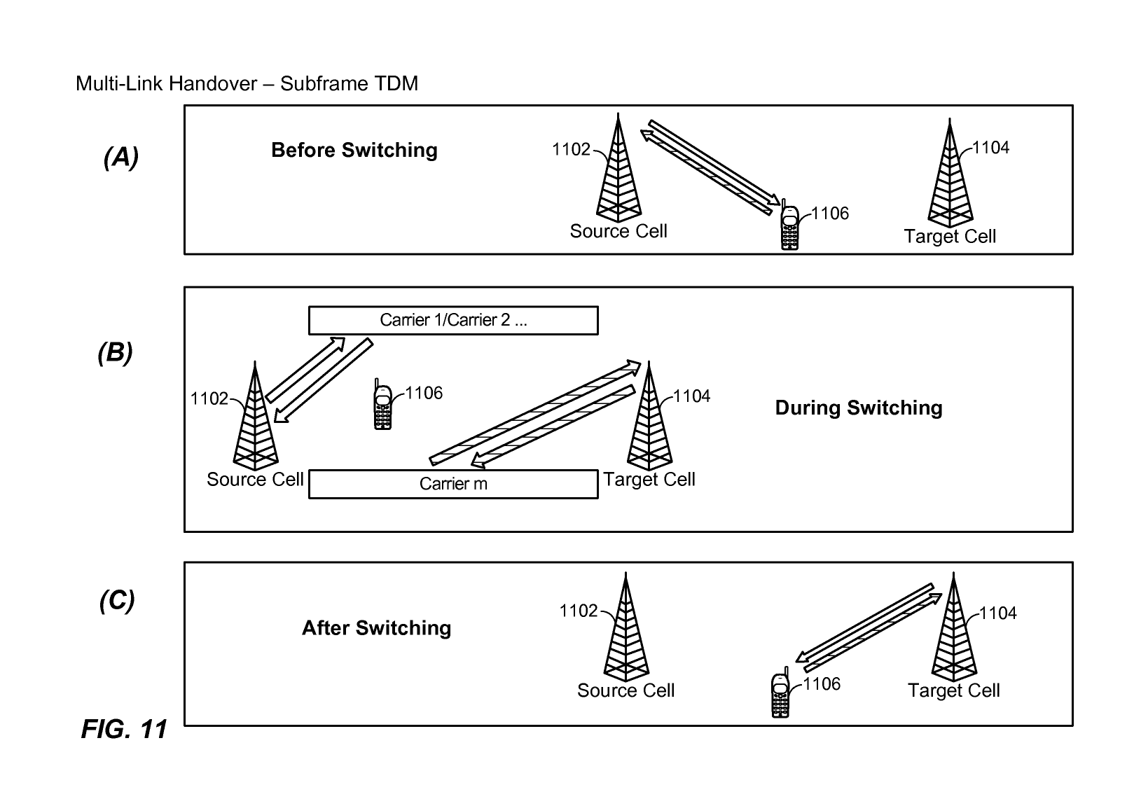

According to an aspect of the present disclosure, as illustrated in FIG. 11 (row B), signaling to/from the source and target Node B for a make-before-break handover in a TD-SCDMA system may be distributed utilizing frequency division multiplexing (FDM). That is, an uplink and a downlink may be provided to/from a source Node B 1102 utilizing a first carrier frequency, and an uplink and a downlink may be provided to/from a target Node B 1104 utilizing a second carrier frequency different from the first carrier frequency. Here, the UE 1106 may be configured to transmit and receive on multiple carriers simultaneously. In this way, during a time while the UE 1106 is establishing a radio link with the target Node B 1104, the UE 1106 may maintain a call with the source Node B 1102. Upon the establishment of the link with the target Node B 1104, the UE 1106 may then accordingly switch the call to the target Node B 1104 and release the link with the source Node B 1102.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a TD-SCDMA system, comprising:
determining to perform a handover from a source cell to a target cell;
establishing a link with the target cell while maintaining a call with the source cell;
terminating a link corresponding to the call with the source cell after the link with the target cell is established; and
continuing the call utilizing the established link with the target cell.

2. The method of claim 1, wherein the establishing of the link with the target cell comprises utilizing feedback to adjust at least one characteristic of the link in response to a measurement of the characteristic of the link.

3. The method of claim 1, wherein the establishing the link with the target cell while maintaining of the call with the source cell comprises time-division multiplexing of information between the source cell and the target cell.

4. The method of claim 3, wherein the time-division multiplexing of the information comprises:
transmitting first information to the source cell during a first time slot of a subframe;
receiving second information from the source cell during a second time slot of the subframe;
transmitting third information to the target cell during a third time slot of the subframe; and
receiving fourth information from the target cell during a fourth time slot of the subframe.

5. The method of claim 4, wherein the transmitting of the first information and the transmitting of the third information each utilize a first carrier, and wherein the receiving of the second information and the receiving of the fourth information each utilize a second carrier.

6. The method of claim 5, further comprising:
redirecting an uplink with the target cell to a third carrier different from the first carrier after the handover is complete; and
redirecting a downlink with the target cell to a fourth carrier different from the second carrier after the handover is complete.

7. The method of claim 6, wherein the redirecting of the uplink to the third carrier and the redirecting of the downlink to the fourth carrier each comprises utilizing the same timing advance (TA) and power control (PC) information as utilized for the first carrier and the second carrier, respectively.

8. The method of claim 3, wherein the time-division multiplexing of the information comprises:
transmitting first information to the source cell during a first subframe of a radio frame;
receiving second information from the source cell during the first subframe of a radio frame;
transmitting third information to the target cell during a second subframe of the radio frame different from the first subframe; and
receiving fourth information from the target cell during the second subframe of the radio frame.

9. The method of claim 1, wherein the maintaining of the call with the source cell while establishing the link with the target cell comprises frequency-division multiplexing of information between the source cell and the target cell.

10. The method of claim 9, wherein the frequency-division multiplexing of the information comprises:
transmitting first information to the source cell utilizing a first carrier;
receiving second information from the source cell utilizing the first carrier;
transmitting third information to the target cell utilizing a second carrier different from the first carrier; and
receiving fourth information from the target cell utilizing the second carrier.

11. A method of wireless communication in a TD-SCDMA network, comprising:
determining to perform a handover from a source cell to a target cell;
providing a target cell handover configuration message to the target cell;
providing a source cell handover configuration message to the source cell;
providing a handover command to a mobile user equipment; and
receiving a handover complete message from the mobile user equipment when the handover is complete.

12. The method of claim 11, wherein the target cell handover configuration message comprises first slot assignments for communication between the target cell and the mobile user equipment during the handover, and wherein the source cell handover configuration message comprises second slot assignments for communication between the source cell and the mobile user equipment during the handover, wherein the first slot assignments correspond to first slots in a sub-frame that are different from second slots in the sub-frame that correspond to the second slot assignments.

13. The method of claim 11, wherein the target cell handover configuration message comprises first sub-frame assignments for communication between the target cell and the mobile user equipment during the handover, and wherein the source cell handover configuration message comprises second sub-frame assignments for communication between the source cell and the mobile user equipment during the handover, wherein the first sub-frame assignments correspond to first sub-frames in a radio frame that are different from second sub-frames in the radio frame that correspond to the second sub-frame assignments.

14. The method of claim 11, wherein the target cell handover configuration message comprises a first carrier assignment for communication between the target cell and the mobile user equipment during the handover, and wherein the source cell handover configuration message comprises a second carrier assignment for communication between the source cell and the mobile user equipment during the handover, wherein the first carrier assignment corresponds to a first carrier frequency that is different from a second carrier frequency that corresponds to the second carrier frequency assignment.

15. An apparatus for wireless communication in a TD-SCDMA system, comprising:
means for determining to perform a handover from a source cell to a target cell;
means for establishing a link with the target cell while maintaining a call with the source cell;
means for terminating a link corresponding to the call with the source cell after the link with the target cell is established; and
means for continuing the call utilizing the established link with the target cell.

16. The apparatus of claim 15, wherein the means for establishing the link with the target cell comprises means for utilizing feedback to adjust at least one characteristic of the link in response to a measurement of the characteristic of the link.

17. The apparatus of claim 15, wherein the means for establishing the link with the target cell while maintaining the call with the source cell comprises means for time-division multiplexing information between the source cell and the target cell.

18. The apparatus of claim 17, wherein the means for time-division multiplexing the information comprises:
means for transmitting first information to the source cell during a first time slot of a subframe;
means for receiving second information from the source cell during a second time slot of the subframe;
means for transmitting third information to the target cell during a third time slot of the subframe; and
means for receiving fourth information from the target cell during a fourth time slot of the subframe.

19. The apparatus of claim 18, wherein the means for transmitting the first information and the means for transmitting the third information are each configured to utilize a first carrier, and wherein the means for receiving the second information and the means for receiving the fourth information are each configured to utilize a second carrier.

20. The apparatus of claim 19, further comprising:
means for redirecting an uplink with the target cell to a third carrier different from the first carrier after the handover is complete; and
means for redirecting a downlink with the target cell to a fourth carrier different from the second carrier after the handover is complete.

21. The apparatus of claim 20, wherein the means for redirecting the uplink to the third carrier and the means for redirecting the downlink to the fourth carrier each comprises means for utilizing the same timing advance (TA) and power control (PC) information as utilized for the first carrier and the second carrier, respectively.

22. The apparatus of claim 17, wherein the means for time-division multiplexing the information comprises:
means for transmitting first information to the source cell during a first subframe of a radio frame;
means for receiving second information from the source cell during the first subframe of a radio frame;
means for transmitting third information to the target cell during a second subframe of the radio frame different from the first subframe; and
means for receiving fourth information from the target cell during the second subframe of the radio frame.

23. The apparatus of claim 15, wherein the means for maintaining of the call with the source cell while establishing the link with the target cell comprises means for frequency-division multiplexing information between the source cell and the target cell.

24. The apparatus of claim 23, wherein the means for frequency-division multiplexing the information comprises:
means for transmitting first information to the source cell utilizing a first carrier;
means for receiving second information from the source cell utilizing the first carrier;
means for transmitting third information to the target cell utilizing a second carrier different from the first carrier; and
means for receiving fourth information from the target cell utilizing the second carrier.

25. A computer program product for use in a TD-SCDMA system, comprising:
a computer-readable medium comprising code for:
determining to perform a handover from a source cell to a target cell;
establishing a link with the target cell while maintaining a call with the source cell;
terminating a link corresponding to the call with the source cell after the link with the target cell is established; and
continuing the call utilizing the established link with the target cell.

26. The computer program product of claim 25, wherein the code for establishing the link with the target cell comprises code for utilizing feedback to adjust at least one characteristic of the link in response to a measurement of the characteristic of the link.

27. The computer program product of claim 25, wherein the code for establishing the link with the target cell while maintaining the call with the source cell comprises code for time-division multiplexing information between the source cell and the target cell.

28. The computer program product of claim 27, wherein the code for time-division multiplexing the information comprises:
code for transmitting first information to the source cell during a first time slot of a subframe;
code for receiving second information from the source cell during a second time slot of the subframe;
code for transmitting third information to the target cell during a third time slot of the subframe; and
code for receiving fourth information from the target cell during a fourth time slot of the subframe.

29. The computer program product of claim 28, wherein the code for transmitting the first information and the code for transmitting the third information are each configured to utilize a first carrier, and wherein the code for receiving the second information and the code for receiving the fourth information are each configured to utilize a second carrier.

30. The computer program product of claim 29, wherein the computer-readable medium further comprises:
code for redirecting an uplink with the target cell to a third carrier different from the first carrier after the handover is complete; and
code for redirecting a downlink with the target cell to a fourth carrier different from the second carrier after the handover is complete.

31. The computer program product of claim 30, wherein the code for redirecting the uplink to the third carrier and the code for redirecting the downlink to the fourth carrier are each configured to utilize the same timing advance (TA) and power control (PC) information as utilized for the first carrier and the second carrier, respectively.

32. The computer program product of claim 27, wherein the code for time-division multiplexing the information comprises:
code for transmitting first information to the source cell during a first subframe of a radio frame;
code for receiving second information from the source cell during the first subframe of a radio frame;
code for transmitting third information to the target cell during a second subframe of the radio frame different from the first subframe; and
code for receiving fourth information from the target cell during the second subframe of the radio frame.

33. The computer program product of claim 25, wherein the code for maintaining the call with the source cell while establishing the link with the target cell comprises code for frequency-division multiplexing information between the source cell and the target cell.

34. The computer program product of claim 33, wherein the code for frequency-division multiplexing the information comprises:
code for transmitting first information to the source cell utilizing a first carrier;
code for receiving second information from the source cell utilizing the first carrier;
code for transmitting third information to the target cell utilizing a second carrier different from the first carrier; and
code for receiving fourth information from the target cell utilizing the second carrier.

35. An apparatus for wireless communication, comprising:
at least one processor; and
a memory coupled to the at least one processor,
wherein the at least one processor is configured to:
determine to perform a handover from a source cell to a target cell;
establish a link with the target cell while maintaining a call with the source cell;
terminate a link corresponding to the call with the source cell after the link with the target cell is established; and
continue the call utilizing the established link with the target cell.

36. The apparatus of claim 35, wherein the establishing of the link with the target cell comprises utilizing feedback to adjust at least one characteristic of the link in response to a measurement of the characteristic of the link.

37. The apparatus of claim 35, wherein the establishing the link with the target cell while maintaining of the call with the source cell comprises time-division multiplexing of information between the source cell and the target cell.

38. The apparatus of claim 37, wherein the time-division multiplexing of the information comprises:
transmitting first information to the source cell during a first time slot of a subframe;
receiving second information from the source cell during a second time slot of the subframe;
transmitting third information to the target cell during a third time slot of the subframe; and
receiving fourth information from the target cell during a fourth time slot of the subframe.

39. The apparatus of claim 38, wherein the transmitting of the first information and the transmitting of the third information each utilize a first carrier, and wherein the receiving of the second information and the receiving of the fourth information each utilize a second carrier.

40. The apparatus of claim 39, wherein the at least one processor is further configured to:
redirect an uplink with the target cell to a third carrier different from the first carrier after the handover is complete; and
redirect a downlink with the target cell to a fourth carrier different from the second carrier after the handover is complete.

41. The apparatus of claim 40, wherein the redirecting of the uplink to the third carrier and the redirecting of the downlink to the fourth carrier each comprises utilizing the same timing advance (TA) and power control (PC) information as utilized for the first carrier and the second carrier, respectively.

42. The apparatus of claim 37, wherein the time-division multiplexing of the information comprises:
transmitting first information to the source cell during a first subframe of a radio frame;
receiving second information from the source cell during the first subframe of a radio frame;
transmitting third information to the target cell during a second subframe of the radio frame different from the first subframe; and
receiving fourth information from the target cell during the second subframe of the radio frame.

43. The apparatus of claim 35, wherein the maintaining of the call with the source cell while establishing the link with the target cell comprises frequency-division multiplexing of information between the source cell and the target cell.

44. The apparatus of claim 43, wherein the frequency-division multiplexing of the information comprises:
transmitting first information to the source cell utilizing a first carrier;
receiving second information from the source cell utilizing the first carrier;
transmitting third information to the target cell utilizing a second carrier different from the first carrier; and
receiving fourth information from the target cell utilizing the second carrier.
